(19) United States
(12) Patent Application Publication
(10) Pub. No.: US 2014/0314063 A1
(43) Pub. Date: Oct. 23, 2014

(54) METHOD AND SYSTEM FOR ESTIMATING CHANNEL BASED ON SIGNAL FIELD CHANNEL INFORMATION IN WIRELESS LOCAL AREA NETWORK (WLAN) SYSTEM

(71) Applicant: Electronics and Telecommunications Research Institute, Daejeon (KR)

(72) Inventors: Chan Wahn YU, Daejeon (KR); Jong Ee OH, Daejeon (KR); Sok Kyu LEE, Daejeon (KR); Hee Soo LEE, Daejeon (KR)

(73) Assignee: Electronics and Telecommunications Research Institute, Daejeon (KR)

(21) Appl. No.: 14/256,116

(22) Filed: Apr. 18, 2014

(30) Foreign Application Priority Data
Apr. 18, 2013 (KR) 10-2013-0042861

(51) Int. Cl. H04W 24/02; H04W 84/12

(52) U.S. Cl. CPC H04W 24/02; H04W 84/12
USPC 370/338

(57) ABSTRACT

Provided is a method of estimating a channel based on signal field channel information in a wireless local area network (WLAN) system, the method including acquiring a first complex storage value based on training field channel information, acquiring a second storage value based on the signal field channel information, setting a first signal and a second signal based on the first complex storage value and the second complex storage value, and generating an output signal based on the first signal and the second signal.

### CROSS-REFERENCE TO RELATED APPLICATION

This application claims the priority benefit of Korean Patent Application No. 10-2013-0042861, filed on Apr. 18, 2013, in the Korean Intellectual Property Office, the disclosure of which is incorporated herein by reference.

### BACKGROUND

1. Field of the Invention

The present invention relates to a method and system for estimating a channel based on signal field channel information in a wireless local area network (WLAN) system and more particularly, technology for estimating the channel by combining the signal field channel information and training field channel information.

2. Description of the Related Art

In technology for estimating a channel in a wireless local area network (WLAN) system, the channel may be estimated by eliminating interference from an inverse matrix for a pilot signal including training field channel information. Here, an interpolation may be used in a process of estimating the channel.

### SUMMARY

An aspect of the present invention provides a method, apparatus, and system for estimating a channel by combining training field channel information and signal field channel information.

Another aspect of the present invention also provides a method, apparatus, and system for using a control signal of a signal field in a process of combining training field channel information and signal field channel information.

Still another aspect of the present invention also provides a method, apparatus, and system for using a complex storage value acquired based on training field channel information and signal field channel information in a process of combining the training field channel information and the signal field channel information.

According to an aspect of the present invention, there is provided a method of estimating a channel based on signal field channel information in a WLAN system, the method including acquiring a first complex storage value based on training field channel information, acquiring a second storage value based on the signal field channel information, setting a first signal and a second signal based on the first complex storage value and the second complex storage value, and generating an output signal based on the first signal and the second signal.

The generating may include selecting a signal having a relatively high intensity by comparing the first signal and the second signal, comparing the selected signal and a preset threshold, and determining the output signal based on a result of the comparing.

The determining may include determining, when the selected signal is greater than the preset threshold, the selected signal to be the output signal.

The determining may include determining, when the selected signal is less than or equal to the preset threshold, the first complex storage value acquired based on the training field channel information to be the output signal.

The setting may include applying a control signal of the signal field to the second complex storage value, and calculating the first signal and the second signal based on the first complex storage value and a result of the applying.

The control signal may have a value of “1” or a value of “−1”.

The calculating may include adding, when the control signal has the value of “1”, the first complex storage value to the second complex storage value and acquiring the first signal.

The calculating may include subtracting, when the control signal has the value of “−1”, the second complex storage value from the first complex storage value, and acquiring the second signal.

According to another aspect of the present invention, there is also provided a system for estimating a channel based on signal field channel information in a WLAN system, the system including an acquirer to acquire a first complex storage value based on training field channel information and a second complex storage value based on the signal field channel information, a setting unit to set a first signal and a second signal based on the first complex storage value and the second complex storage value, and a generator to generate an output signal based on the first signal and the second signal.

The generator may include a selecting unit to compare the first signal and the second signal and select a signal having a relatively high intensity, a comparator to compare the selected signal and a preset threshold, and determiner to determine the output signal based on a result of the comparing.

The determiner may determine the selected signal to be the output signal when the selected signal is greater than the preset threshold.

The determiner may determine the first complex storage value acquired based on the training field channel information to be the output signal when the selected signal is less than or equal to the preset threshold.

The setting unit may include an applicator to apply a control signal of the signal field to the second complex storage value, and a calculator to calculate the first signal and the second signal based on the first complex storage value and a result of the applying.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a wireless communication network according to an embodiment of the present invention;

FIG. 2 is a diagram illustrating a transmission system according to an embodiment of the present invention;

FIG. 3 is a diagram illustrating a station (STA) K transmitter 240 of FIG. 2;

FIG. 4 is a diagram illustrating a reception system according to an embodiment of the present invention;

FIG. 5 is a diagram illustrating a data transmission configuration according to an embodiment of the present invention;

FIG. 6 is a diagram illustrating a channel estimation system according to an embodiment of the present invention;

FIG. 7 is a flowchart illustrating a channel estimation method according to an embodiment of the present invention;

FIG. 8 is a flowchart illustrating an operation of setting a first signal and a second signal in the method of FIG. 7;

FIG. 9 is a flowchart illustrating an operation of generating an output signal in the method of FIG. 7; and

FIG. 10 is a block diagram illustrating a channel estimation system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

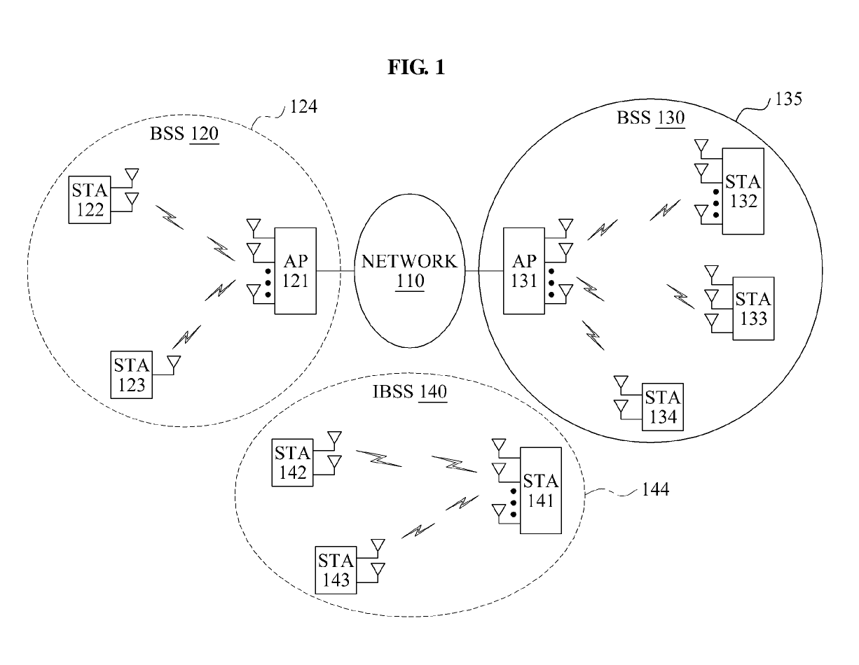

FIG. 1 is a diagram illustrating a wireless communication network according to an embodiment of the present invention.

Referring to FIG. 1, the wireless communication network may indicate a network 110 including an access point (AP) 121 and an AP 131.

Here, the AP 121 indicating an access point may communicate with a station (STA) 122 and an STA 123 included in a basic service set (BSS) 120 having a communication range 124. Also, the AP 131 may communicate with an STA 132, and STA 133 and an STA 134 included in a BSS 130 having a communication range 135. In this instance, the AP 121 may communicate with each of the STA 122 and the STA 123, and also communicate to the STA 122 and the STA 123 simultaneously.

In an independent basic service set (IBSS) 140 having a communication range 144, an STA 141, an STA 142, and an STA 143 may communicate to each other without an AP.

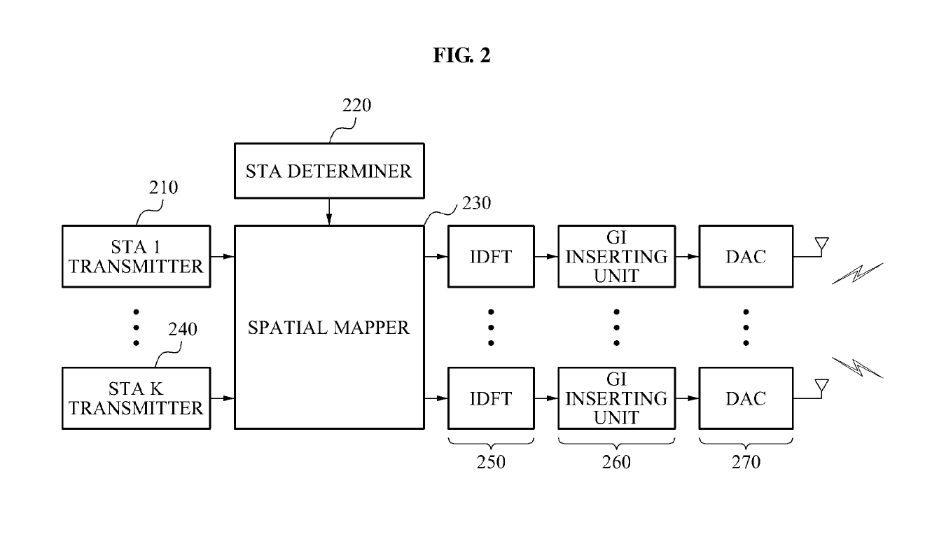

FIG. 2 is a diagram illustrating a transmission system according to an embodiment of the present invention.

Referring to FIG. 2, the transmission system includes an STA 1 transmitter 210, an STA determiner 220, a spatial mapper 230, an STA K transmitter 240, an inverse discrete Fourier transform (IDFT) unit 250, a guard interval (GI) inserting unit 260 and a digital-to-analog converter (DAC) 270.

Here, the STA 1 transmitter 210 may simultaneously transmit at least one transmission signal of an STA. In a case of using channel information, the STA determiner 220 may determine a weight vector using a multiple-input and multiple-output (MIMO) channel, and determine an STA to transmit and a number of STAs to transmit, simultaneously.

In addition, in a case of not using the channel information, the spatial mapper 230 may map a weight on the STAs based on a unit matrix. In a case of using the channel information, the spatial mapper 230 may map the weight on the STAs based on the determined weight vector.

The IDFT unit 250 may perform an inverse discrete transformation on a signal transferred by the spatial mapper 230.

Also, the GI inserting unit 206 may insert a GI in the signal on which the inverse discrete transformation is performed. The DAC 270 may perform a digital-to-analog (D/A) conversion on the signal in which the GI is inserted, and transmit the signal through a radio frequency (RF).

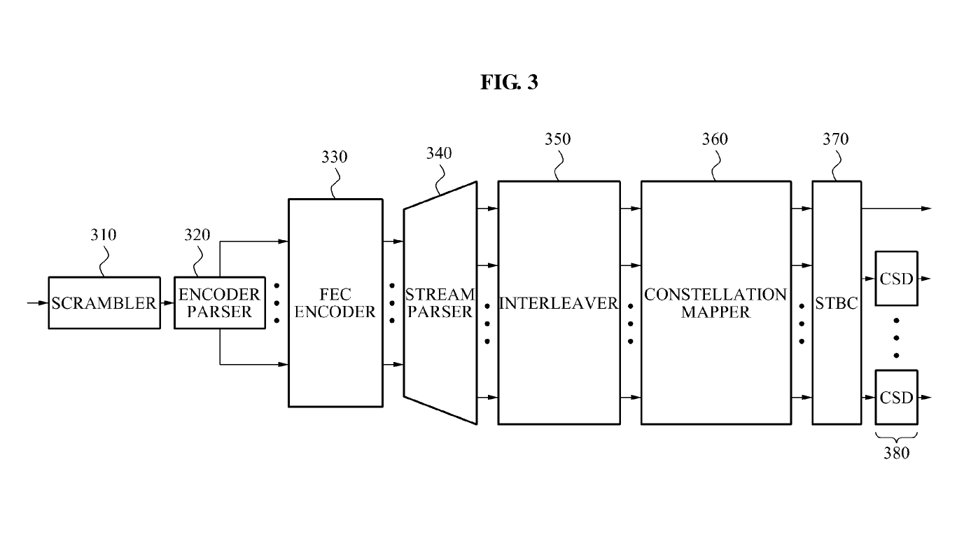

FIG. 3 is a diagram illustrating the STA K transmitter 240 of FIG. 2. Referring to FIG. 3, the STA K transmitter 240 includes a scrambler 310, an encoder parser 320, a forward error correction (FEC) encoder 330, a stream parser 340, an interleaver 350, a constellation mapper 360, a space-time block code (STBC) unit 370, and a cyclic shift delay (CSD) unit 380.

Here, the scrambler 310 may scramble data to be transmitted, and the encoder parser 320 may divide a scrambled signal by an encode number.

The FEC encoder 330 may perform FEC encoding, and the stream parser 340 may divide the FEC encoded signal by a number of streams.

Also, the interleaver 350 may perform interleaving on the divided signal, and the constellation mapper 360 may map the interleaved signal using at least one of binary phase-shift keying (BPSK), quadrature phase-shift keying (QPSK), 16 quadrature amplitude modulation (QAM), 64 QAM, and 256 QAM.

The STCB unit 370 may perform space-time block coding on the signal transferred by the constellation mapper 360, and the CSD unit 380 may generate the CSD.

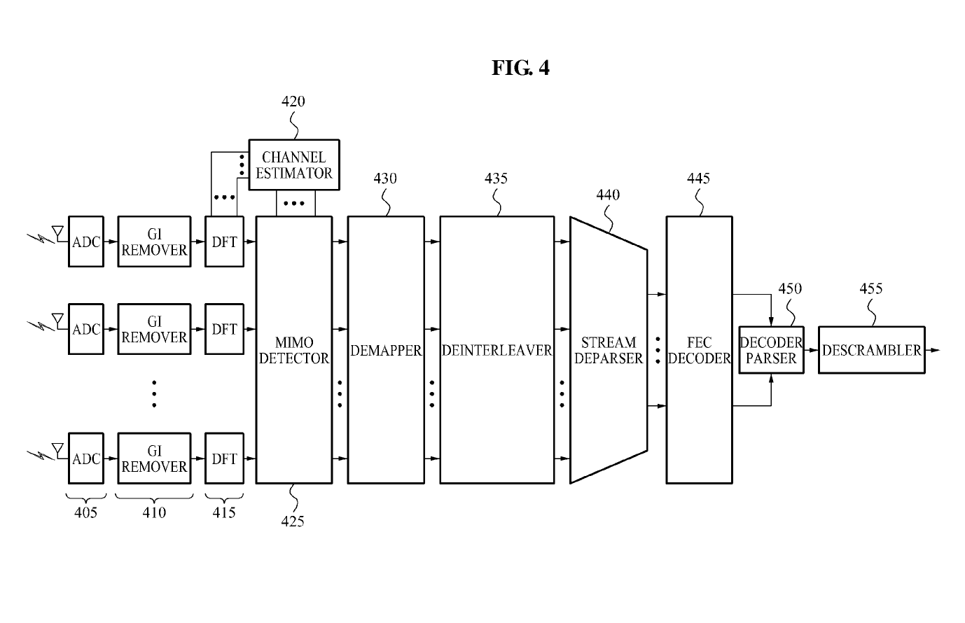

FIG. 4 is a diagram illustrating a reception system according to an embodiment of the present invention.

Referring to FIG. 4, the reception system includes an analog-to-digital converter (ADC) 405, a GI remover 410 a DFT unit 415, a channel estimator 420, a MIMO detector 425, a demapper 430, a deinterleaver 435, a stream deparser 440, a FEC decoder 445, a decoder parser 450, and a descrambler 455.

Here, the ADC 405 may perform an analog-to-digital (A/D) conversion on an RF signal. The GI remover 410 may perform at least one of carrier sensing, automatic gain control (AGC), timing synchronization, and frequency offset estimation, and remove a GI.

In addition, the DFT unit 415 may perform a discrete transformation, and the channel estimator 420 may estimate a channel of a signal on which the discrete transformation is performed. In this instance, the signal may be a long training field (LFT).

The MIMO detector 425 may demodulate data based on a result of channel estimation, and the demapper 430 may convert the demodulated signal into a soft value required for FEC decoding.

Also, the deinterleaver 435 may perform deinterleaving on the converted signal, and the stream deparser 440 may divide the deinterleaved signal by a number of the FEC decoders 445.

The FEC decoder 445 may perform FEC decoding for each of the divided signals, and the decoder parser 450 may integrate the decoded signals into a single signal.

The descrambler 455 may descramble a signal to restore transmitted data.

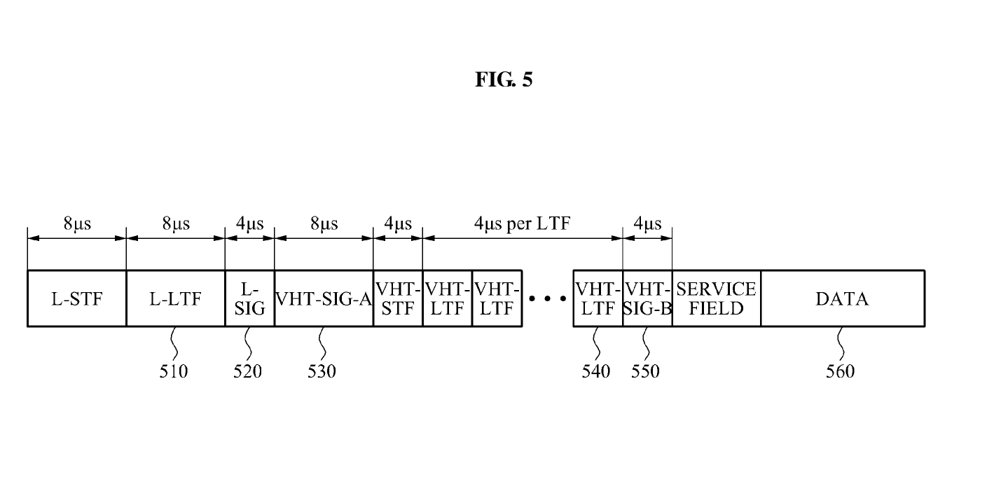

FIG. 5 is a diagram illustrating a data transmission structure according to an embodiment of the present invention.

Referring to FIG. 5, the data transmission structure according to an embodiment of the present invention may be provided in an 802.11 ac very high throughput (VHT) WLAN physical layer frame structure, and also provided in a structure of a legacy short training field (L-STF), a legacy long training field (L-LTF) 510, a legacy signal (L-SIG) 520, and a VHT-SIG-A 530 for backward compatibility.

Here, the L-LTF 510 may correspond to a training sequence used for wireless channel estimation of a signal of the L-SIG 520 and a signal of the VHT-SIG-A 530, and use a BPSK signal as modulation scheme.

A VHT-LTF 540 may correspond to a training sequence used for wireless channel estimation of a signal of a VHT-SIG-B 550 and a signal of data 560, and use the BPSK signal as modulation scheme.

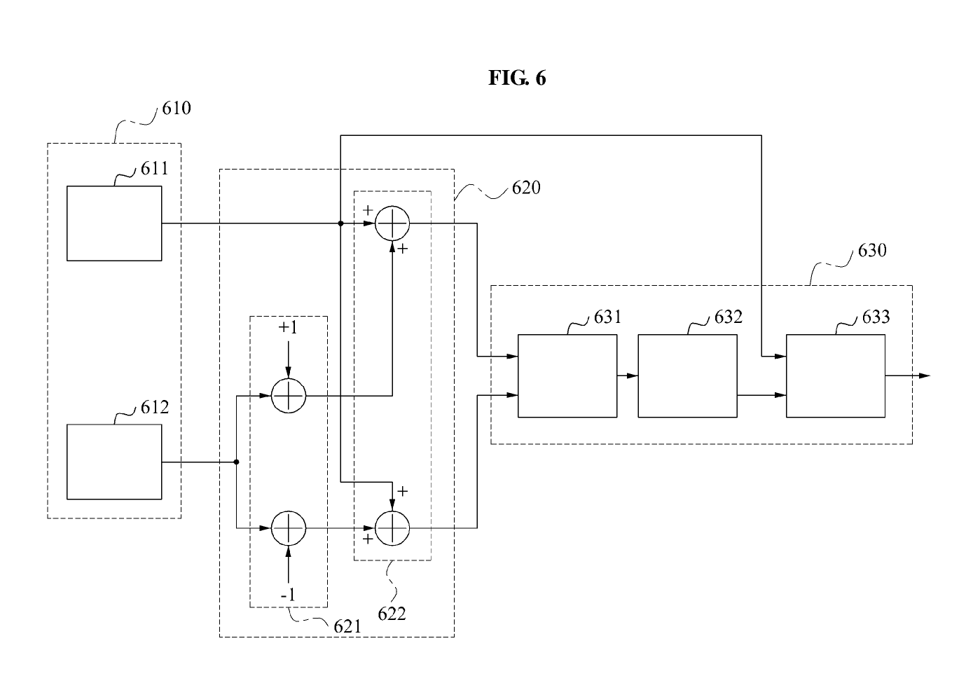

FIG. 6 is a diagram illustrating a channel estimation system according to an embodiment of the present invention.

Referring to FIG. 6, the channel estimation system includes an acquirer 610, a setting unit 620, and a generator 630.

Here, the acquirer 610 may include a first acquirer 611 to acquire a first complex storage value based on training field channel information and a second acquirer 612 to acquire a second complex storage value based on signal field channel information. In this instance, the first complex storage value may be a reception complex storage value of a VHT-LTF passing through a wireless channel, and the second complex storage value may be a reception complex storage value of a VHT-SIG-B passing through the wireless channel.

The setting unit 620 may include an applicator 621 to apply a control signal of the signal field to the second complex storage value, and a calculator 622 to calculate a first signal and a second signal based on a result of the applying and the first complex storage value. Here, the control signal may have a value of “1” or a value of “−1”. When the control signal has the value of “1”, the calculator 622 may calculate a value acquired by adding the first complex storage value and the second complex storage value as shown in Equation 1, thereby acquiring the first signal.

U(k)=H(k)+R(k) [Equation 1]

In Equation 1, U(k) denotes the first signal, H(k) denotes the first complex storage value, and R(k) denotes the second complex storage value. When the control signal has the value of “−1” the calculator 622 may calculate a value obtained by subtracting the second complex storage value from the first complex storage value as shown in Equation 2, thereby acquiring the second signal.

L(k)=H(k)−R(k) [Equation 2]

In equation 2, L(k) denotes the second signal, H(k) denotes the first complex storage value, and R(k) denotes the second complex storage value.

The generator 630 may include a selecting unit 631 to select a signal having a relatively high intensity by comparing the first signal and the second signal, a comparator 632 to compare the selected signal and a preset threshold, and a determiner 633 to determine an output signal based on a result of the comparing.

When the selected signal is greater than the preset threshold, the determiner 633 may determine the selected signal to be the output signal. When the selected signal is less than or equal to the preset threshold, the determiner 633 may determine the first complex storage value acquired based on the training field channel information to be the output signal.

For example, the selecting unit 631 may compare U(k), the first signal, and L(k), the second signal, and select a value of U(k) having a relatively high intensity. The comparator 632 may compare the selected signal, the value of U(k), and the preset threshold, and transfer a result of the comparing to the determiner 633. When the value of U(k) is greater than the preset threshold, the determiner 633 may determine the value of U(k) to be the output signal, in response thereto. When the value of U(k) is less than or equal to the preset threshold, the determiner 633 may determine H(k), the first complex storage value acquired based on the training field channel information, to be the output signal.

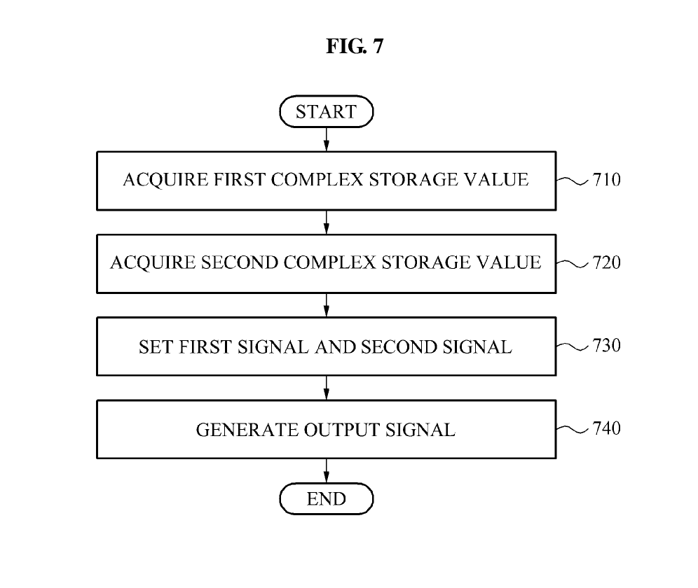

FIG. 7 is a flowchart illustrating a channel estimation method according to an embodiment of the present invention.

Referring to FIG. 7, in operation 710, a first complex storage value may be acquired based on training field channel information.

In operation 720, a second complex storage value may be acquired based on signal field channel information.

In operation 730, a first signal and a second signal may be set based on the first complex storage value and the second complex storage value.

In operation 740, an output signal may be generated based on the first signal and the second signal.

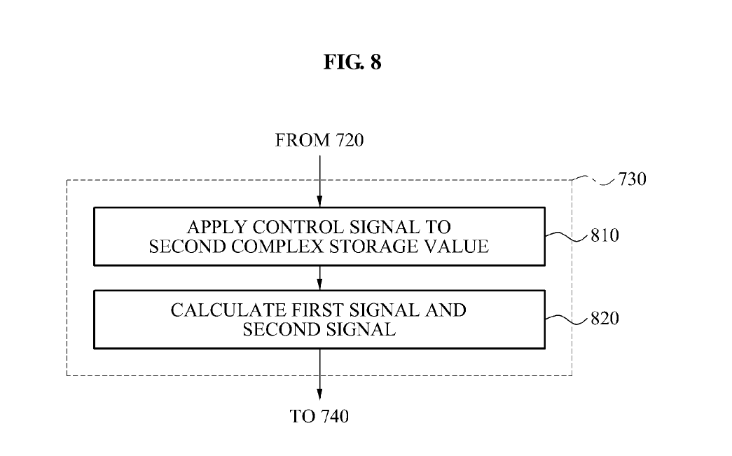

FIG. 8 is a flowchart illustrating operation 730 of setting the first signal and the second signal in the method of FIG. 7.

Referring to FIG. 8, in operation 810, a control signal of a signal field may be applied to a second complex storage value. Here, the control signal may have a value of “1” or a value of “−1”.

In operation 820, the first signal and the second signal may be calculated based on a first complex storage value and a result of the applying. When the control signal has the value of “1”, the first signal may be acquired by adding the first complex storage value to the second complex storage value in a process of calculating the first signal and the second signal. When the control signal has the value of “−1”, the second signal may be acquired by subtracting the second complex storage value from the first complex storage value in the process of calculating the first signal and the second signal.

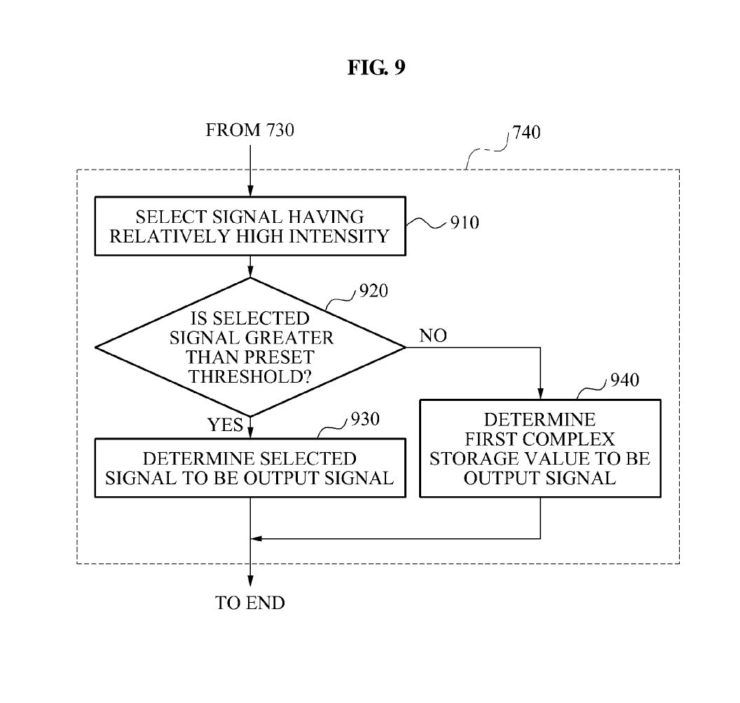

FIG. 9 is a flowchart illustrating operation 740 of generating the output signal in the method of FIG. 7.

Referring to FIG. 9, in operation 910, a first signal may be compared to a second signal, and a signal having a relatively high intensity may be selected from the first signal and the second signal.

In operation 920, the selected signal may be compared to a preset threshold.

In operation 930, when the selected signal is greater than the preset threshold, the selected signal may be determined to be the output signal.

In operation 940, when the selected signal is less than or equal to the preset threshold, a first complex storage value acquired based on training field channel information may be determined to be the output signal.

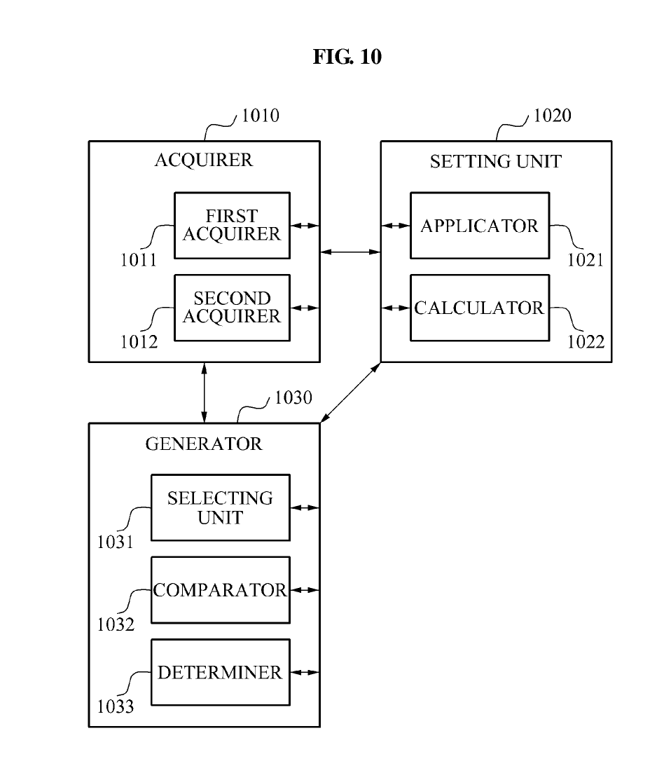

FIG. 10 is a block diagram illustrating a channel estimation system according to an embodiment of the present invention.

Referring to FIG. 10, the channel estimation system includes an acquirer 1010, a setting unit 1020, and a generator 1030.

The acquirer 1010 may include a first acquirer 1011 to acquire a first complex storage value based on training field channel information, and a second acquirer 1012 to acquire a second complex storage value based on signal field channel information.

The setting unit 1020 may set a first signal and a second signal based on the first complex storage value and the second complex storage value.

In this instance, the setting unit 1020 may include an applicator 1021 to apply a control signal of the signal field to the second complex storage value, and a calculator 1022 to calculate the first signal and the second signal based on the first complex storage value and a result of the applying.

The generator 1030 may set an output signal based on the first signal and the second signal.

In this instance, the generator 1030 may include a selecting unit 1031 to select a signal having a relatively high intensity by comparing the first signal and the second signal, a comparator 1032 to compare the selected signal and a preset threshold, and a determiner 1033 to determine the output signal based on a result of the comparing.

According to an embodiment of the present invention, it is possible to provide a method, apparatus, and system for estimating a channel by combining training field channel information and signal field channel information.

According to another embodiment of the present invention, it is also possible to provide a method, apparatus, and system for using a control signal of a signal field in a process of combining training field channel information and signal field channel information.

According to still another embodiment of the present invention, it is also possible to provide a method, apparatus, and system for using a complex storage value acquired based on training field channel information and signal field channel information in a process of combining the training field channel information and the signal field channel information.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The methods according to the above-described embodiments may be recorded, stored, or fixed in one or more non-transitory computer-readable media that includes program instructions to be implemented by a computer to cause a processor to execute or perform the program instructions. The media may also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of estimating a channel based on signal field channel information in a wireless local area network (WLAN) system, the method comprising:
acquiring a first complex storage value based on training field channel information;
acquiring a second storage value based on the signal field channel information;
setting a first signal and a second signal based on the first complex storage value and the second complex storage value; and
generating an output signal based on the first signal and the second signal.

2. The method of claim 1, the generating includes selecting a signal having a relatively high intensity by comparing the first signal and the second signal, comparing the selected signal and a preset threshold, and determining the output signal based on a result of the comparing.

3. The method of claim 1, the determining includes determining, when the selected signal is greater than the preset threshold, the selected signal to be the output signal.

4. The method of claim 1, the determining includes determining, when the selected signal is less than or equal to the preset threshold, the first complex storage value acquired based on the training field channel information to be the output signal.

5. The method of claim 1, the setting includes applying a control signal of the signal field to the second complex storage value, and calculating the first signal and the second signal based on the first complex storage value and a result of the applying.

6. The method of claim 5, the control signal has a value of “1” or a value of “−1”.

7. The method of claim 1, the calculating includes adding, when the control signal has the value of “1”, the first complex storage value to the second complex storage value and acquiring the first signal.

8. The method of claim 1, the calculating includes subtracting, when the control signal has the value of “−1”, the second complex storage value from the first complex storage value, and acquiring the second signal.

9. A system of estimating a channel based on signal field channel information in a wireless local area network (WLAN) system, the system comprising:
an acquirer configured to acquire a first complex storage value based on training field channel information and a second complex storage value based on the signal field channel information;
a setting unit configured to set a first signal and a second signal based on the first complex storage value and the second complex storage value; and
a generator configured to generate an output signal based on the first signal and the second signal.

10. The system of claim 9, the generator includes a selecting unit configured to compare the first signal and the second signal and select a signal having a relatively high intensity, a comparator configured to compare the selected signal and a preset threshold, and determiner configured to determine the output signal based on a result of the comparing.

11. The system of claim 9, the determiner determines the selected signal to be the output signal when the selected signal is greater than the preset threshold.

12. The system of claim 9, the determiner determines the first complex storage value acquired based on the training field channel information to be the output signal when the selected signal is less than or equal to the preset threshold.

13. The system of claim 9, the setting unit includes an applicator configured to apply a control signal of the signal field to the second complex storage value, and a calculator configured to calculate the first signal and the second signal based on the first complex storage value and a result of the applying.
